(19) United States
(12) Patent Application Publication
(10) Pub. No.: US 2006/0118522 A1
(43) Pub. Date: Jun. 8, 2006

(54) Etching composition and use thereof with feedback control of HF in BEOL clean

(76) Inventors: Ravikumar Ramachandran, Ossining, NY (US); Klaus Penner, Ottendorf-Okrilla (DE); Marion Nichterwitz, Dresden (DE); Christiane Nitschke, Dresden (DE); Holger Krause, Dresden (DE)

Correspondence Address: SLATER & MATSIL LLP, 17950 PRESTON ROAD, SUITE 1000, DALLAS, TX, 75252, US

(21) Appl. No.: 11/341,761

(22) Filed: Jan. 27, 2006

Related U.S. Application Data
(62) Division of application No. 10/403,269, filed on Mar. 31, 2003.
Application No. 10/403,269 is a division of application No. 09/627,669, filed on Jul. 28, 2000, now abandoned.

(51) Int. Cl. B44C 1/22; C23F 1/00

(52) U.S. Cl. 216/83; 216/88

(57) ABSTRACT

In a process for making a semiconductor device, a first aqueous mixture is prepared and a fluorine-containing compound is combined with the first aqueous mixture to obtain an etchant composition. A sample of the etchant composition is taken and compared to a standard dilute solution of the fluorine-containing compound to obtain a value of fluorine-containing compound concentration in said sample. The value is input to a tank tool recipe control to cause an adjustment in the concentration of the fluorine-containing compound in the etchant composition. A surface of a semiconductor wafer can then be subjected to etching by the etchant composition.

This application is a divisional of co-pending patent application Ser. No. 10/403,269, filed Mar. 31, 2003, which is a divisional of application Ser. No. 09/627,669, filed Jul. 28, 2000, which applications are both incorporated herein by reference in their entirety.

### CROSS-REFERENCE TO RELATED APPLICATIONS

This application is related to U.S. Pat. No. 6,630,074, abandoned application Ser. No. 08/975,755 (filed on Nov. 21, 1997), and U.S. Pat. No. 5,780,363, which are all incorporated herein by reference in their entirety.

### TECHNICAL FIELD

The present invention is concerned with an etchant composition and especially with a composition that is capable of removing inorganic polymer residue present on a substrate due to a previous metal reactive ion etching process. In addition, the present invention is directed to a method for removing such polymer and via residue by employing the etchant compositions of the present invention.

### BACKGROUND

Aluminum and aluminum alloys are frequently used for the “metallizations” in large scale integrated circuits. The aluminum alloys include those with small amounts of copper for reducing the potential for electromigration effects, where current applied to the device induces transport of the aluminum atoms. Small amounts of silicon or titanium have been added to aluminum in order to minimize the possibility of electrical spiking that can occur in contact holes.

In order to form the patterned metallization, a series of process steps are carried out. These include depositing a layer containing aluminum, coating a photoresist film onto the aluminum containing layer, creating in the photoresist film an image of the predetermined required pattern, such as by exposing selected portions of the photoresist film to light passing through a mask or grating, and then removing either the exposed or unexposed portions of the photoresist film, depending upon the type of resist employed, and finally removing the aluminum or aluminum alloy layer in the regions not masked by the remaining photoresist film. Next, the remaining photoresist film can be removed.

More particularly, aluminum/copper metal line for BEOL wiring/interconnect in semiconductor devices are currently delineated by a reactive ion etching process. Such a process involves patterning the aluminum/copper metal layer with a photoresist and then reactive ion etching (RIE) in a chlorine environment using boron trichloride, HCl gas, Cl₂ or any other chlorine containing reactive species in order to etch away the exposed aluminum/copper layer. However, such etching process leaves a residue around the metal lines which consist of complex polymeric oxides of aluminum along with incorporating chlorine into the inorganic matrix. This is typically referred to as sidewall polymer residue, and its presence is a troublesome source of corrosion of the Al/Cu lines when exposed to the environment such as atmospheric air and/or humidity. Moreover, trace amounts of chlorine over time break down the passivating layer of aluminum oxide and corrode the underlying aluminum. Traditionally, the use of fluoride containing compounds in general, and hydrofluoric acid in particular, has been avoided because it has the tendency to degrade the quality of metal lines in general, and aluminum in particular.

Additionally, after a RIE process, sidewall polymers remain on the semiconductor wafer surface. These sidewall polymers known as “polymer rails” are inorganic in nature and have various chemical constituents, including aluminum, silicon, titanium, oxygen, carbon and chlorine. Since each of their constituents tends to react and/or interfere with the semiconductor wafer function, removal of the sidewall polymers is therefore desirable. A post metal RIE cleaning step is presently done using a chromic/phosphoric acid etch, or solvent based chemistry methods. However, one common chemical constituent with a solvent based chemistry is an amine which can cause problems with certain types of photoresists. Solutions which are based on diluted sulfuric acid and hydrogen peroxide mixtures have been introduced in an attempt to remove polymer rails. However, these methods have not been successful in removing all types of polymer rails.

For example, as shown in FIG. 1, in regions where there is an isolated metal pad which has a metal line density lower than the array region of the semiconductor chip and a surrounding region which is predominantly silicon oxide, current methods are less than completely successful. FIG. 1 illustrates a situation where the use solution of the present invention would be indicated. In FIG. 1, a wafer is shown after it has undergone a RIE process. The direction of the RIE process is shown by the arrow. The structure shown 10, can be comprised of multiple layers. For example, there can be an oxide layer 11, and a conductive layer 12. The RIE process selectively removed portions of the conductive layer 12 to expose the oxide layer 11. Accordingly, there is little to no residual left on the surface 5, of the oxide 11. The RIE process was, in this case, directed at the surface 5, as shown by the arrow. However, the structure 10, may contain a solid film 15, covering the sidewalls 13 and the top 14, of the structure 10.

Alternatively, as shown in FIG. 2, the etchant is useful for processing steps not involving polymer etching. For example, there could be regions in an oxide layer, where a via 25, has been previously formed and filled. Preferably, the material filling the via 25, would be a conductive material. The via 25 may provide electrical communication between different levels of the wafer. The etchant solution of the instant invention would also be useful for cleaning the via 20, which is opened to the via 25, of many types of residue material. Residue materials include, but are not limited to oxygen, silicon, carbon and elements of an underlying conductive layer.

Accordingly, methods are utilized for removing this sidewall polymer residue, polymer rails, and via residue. One of the more popular methods employs a chromic/phosphoric acid bath. However, this procedure is only marginally effective. Moreover, the chromic/phosphoric acid bath tends to cause some electrochemical etching of aluminum, especially near a tungsten stud, which are typically present, thereby causing degradation of the aluminum metal layer.

Therefore, providing an etching process capable of removing the sidewall polymer and via residue that does not etch conductive materials, especially aluminum, to any undesired extent, while removing the sidewall polymer, polymer rails, and via residue would be desirable.

It would also be desirable to use the etchant composition of the invention in a controlled manner for aqueous back-end-of-line (BEOL) clean for interconnects, as the aqueous chemistry of an aqueous mixture of sulfuric acid, hydrogen peroxide, and very small amounts of HF introduces new challenges in the manufacturing process. That is, it is especially important to control and monitor the concentration of the active etching constituent, HF. Because of the fact that the concentration level of HF in the mixture is in the ppm range, it is necessary to incorporate a feedback control mechanism to use this composition effectively for interconnect cleaning in the BEOL.

### SUMMARY OF THE INVENTION

One object of the present invention is to provide an etchant composition that is capable of removing via residue and not adversely effect the aluminum lines or lines made of other conductive materials. Moreover, the etching composition of the present invention is quite acceptable from an environmental point of view. Additionally, the etchant composition is particularly useful in removing inorganic polymers attached to the metal lines in isolated regions where there may be a higher silicon concentration as compared to the array regions.

Another object of the present invention is to remove polymer and via residue from a substrate which comprises contacting the substrate with an aqueous solution containing about 0.01 to about 15 percent by weight of sulfuric acid, and about 0.01 to about 20 percent by weight of hydrogen peroxide, or about 1 to about 30 ppm of ozone, and about 0.1 to about 100 ppm of a fluoride containing compound.

A further object of the present invention is to provide a process control methodology for the new aqueous clean for use in back-end-of-line (BEOL) clean for interconnects, where the aqueous chemistry is an aqueous mixture of sulfuric acid, hydrogen peroxide, and very small amounts of HF, as the use of this chemistry in manufacturing introduces new challenges, and it is important to control and monitor the concentration of the active etching constituents, HF.

The etchant composition of the present invention is an aqueous solution containing about 0.01 to about 15 percent by weight of sulfuric acid, about 0.01 to about 20 percent by weight of hydrogen peroxide, or about 1 to about 30 ppm of ozone, and about 0.1 to about 100 ppm of hydrofluoric acid.

Still other objects and advantages of the present invention will become readily apparent to those skilled in this art from the following detailed description, wherein it is shown and described only the preferred embodiments of the invention, simply by way of illustration of the best mode contemplated of carrying out the invention. As will be realized, the invention is capable of other and different embodiments, and its several details are capable of modifications in various obvious respects, without departing from the invention. Accordingly, the description is to be regarded as illustrative in nature and not as restrictive.

### BRIEF DESCRIPTION OF THE DRAWINGS

These and other features, aspects, and advantages will be more readily apparent and better understood from the following detailed description of the invention, in which:

FIG. 1 is a cross-sectional view of a portion of a semiconductor device illustrating a problem the instant invention is seeking to solve.

FIG. 2 is a cross-sectional view of a portion of a semiconductor device illustrating a problem the instant invention is seeking to solve.

FIG. 3 is a schematic of a flow diagram showing the method of delivery of the chemistry to an open tank for an aqueous back-end-of-line (BEOL) clean for interconnects.

FIG. 4 is a schematic of a flow diagram for on-line HF monitoring of the aqueous clean for back-end-of-line (BEOL) clean for interconnects.

FIG. 5 is a schematic of a flow diagram of a process control for the aqueous back-end-of-line (BEOL) clean for interconnects where the process implementation is extended to wafer processing in a spray processor.

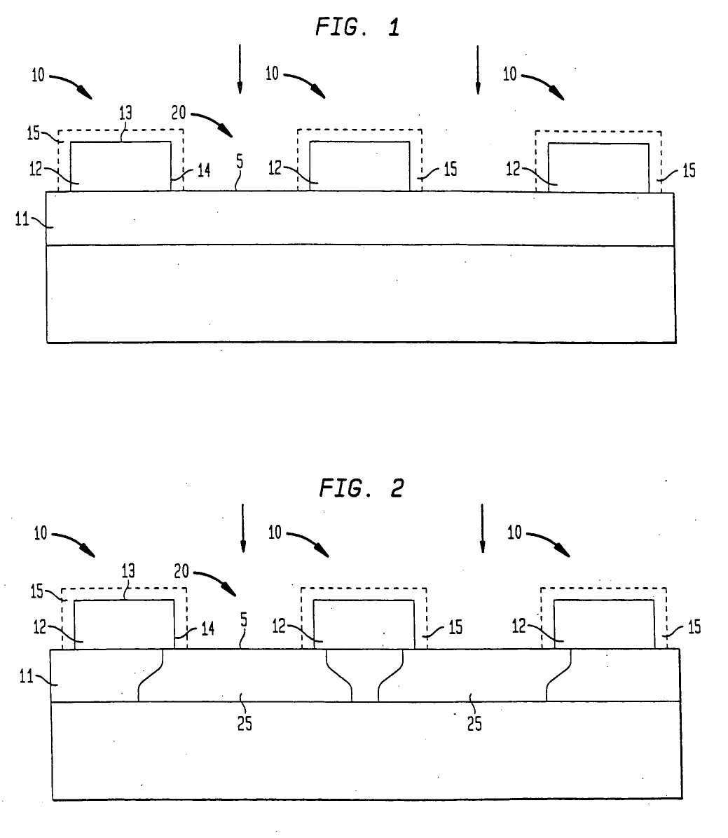

### DETAILED DESCRIPTION OF ILLUSTRATIVE EMBODIMENTS

The etchant compositions of the present invention are aqueous solutions containing about 0.01 to about 15 percent by weight and preferably about 1 to about 10 percent by weight of sulfuric acid and about 0.01 to about 20 percent by weight of hydrogen peroxide, 0.1 to about 100 ppm of hydrofluoric acid and preferably about 1 to about 10 percent by weight of hydrogen peroxide or about 1 to about 30 ppm and preferably about 5 to about 20 ppm of ozone with the balance being substantially water, and more preferably contain about 0.1 to about 100 ppm of a fluoride containing compound, preferably hydrofluoric acid. It is not necessary that the fluoride containing compound be hydrofluoric acid. It is necessary that the fluoride containing compound contribute free fluoride to the etchant composition. It is preferred that the fluoride containing compound be able to contribute the equivalent of at least about 8 and at most about 12 ppm of hydrofluoric acid to the etchant solution. A preferred composition of the present invention is an aqueous solution of about 8 percent by weight of sulfuric acid, and about 1.5 percent by weight of hydrogen peroxide and the remainder being substantially water, and more preferably contain about 10 ppm of a fluoride containing compound, preferably hydrofluoric acid. This composition is preferably employed at temperatures of about 35° C. Another more preferred composition of the present invention is an aqueous solution of about 9 percent by weight sulfuric acid and about 4 percent by weight hydrogen peroxide and the remainder being substantially water, and more preferably contain about 10 ppm of a fluoride containing compound, preferably hydrofluoric acid. This composition is preferably employed at temperatures of about 35° C., and is especially preferred for removing thicker and more tenacious sidewall polymer. Yet another more preferred composition of the present invention is an aqueous solution of about 5% by weight of sulfuric acid, about 12% by weight of hydrogen peroxide and about 10 ppm hydrogen fluoride. The water employed is preferably deionized water.

These etchant compositions of the present invention can be prepared by admixing an aqueous sulfuric acid such as a 98 percent by weight solution with an aqueous solution of hydrogen peroxide such as a 30 percent by weight solution and aqueous hydrofluoric acid such as 49 percent by weight and adding these solutions to water in an amount to provide the desired percentage of the sulfuric acid, hydrogen peroxide, and hydrofluoric acid.

The compositions containing the ozone can be prepared by bubbling ozone gas into the aqueous composition containing the desired amounts of sulfuric acid and water, or diffusing ozone gas through a membrane into water and then adding sulfuric acid to the water, or by any other suitable method.

The etchant compositions of the present invention remove the sidewall polymer residue remaining after the reactive ion etching and with it removes any embedded chlorine. The etchant compositions of the present invention also clean vias of other residues, including, but not limited to, oxygen, carbon, silicon and elements of an underlying conductive material. Furthermore, the etchant compositions of the present invention, at most, only mildly etch the aluminum/copper line. Since hydrofluoric acid is known to etch aluminum/copper, the amounts in the etchant solution must be small. When the amounts of hydrofluoric acid in the claimed etchant solution are kept small (less than about 40 ppm) the potentially detrimental effects of the hydrofluoric acid on aluminum/copper are minimized. For HF concentration greater than 40 ppm and less than 100 ppm, the process times would be short, typically less than 1 minute. In most cases, no evidence of any local etching of the aluminum, even aluminum in the vicinity of tungsten studs, has been observed. The tungsten seems to act as a catalyst in etching aluminum when using the prior art chromic/phosphoric acid bath. They also can be used to remove and clean residues after chemical-mechanical polishing and other “cleaning” processing steps.

The etchant compositions of the present invention also result in the formation of a pristine native oxide of aluminum, which acts as a passivating layer against subsequent corrosion. For instance, an oxide thickness of about 30 angstroms as measured by Auger Spectroscopy is obtained using an etchant composition at about 35° C., containing about 2.0 percent by weight of sulfuric acid, about 1.0 percent by weight of hydrogen peroxide and about 10 ppm of hydrofluoric acid.

The above disclosed relative amounts of components of the composition tend to prevent redeposition of the polymer residue. This occurs by having the pH of the etchant such that the charges of the zeta potentials of the aluminum oxide species and the silicon oxide surface of the substrate cause a repulsion interaction between the surfaces. The desired pH is ensured by observing the amounts of ingredients mentioned above. The zeta potential reflects the charge induced on a surface caused by the interactions of that surface with the ions in the solution, primary, hydrogen and hydroxide. At a certain solution pH, the net surface charge will be zero which occurs at about pH 2 to 3 for silica and at about pH 9 to 10 for alumina. When the pH is less than this point of zero charge, the charge on the surface would be positive. For the case of a polymer residue removed in an acid medium, the propensity of redeposition of the residue on either the oxidized aluminum surface or on the silica dielectric material is reduced because all surfaces would have a charge of the same sign with zeta potentials also of the same sign. It should be noted that HF acid in the concentrations employed in the present invention (less than about 100 ppm) do not result in significant changes in the pH of the resulting etchant solution.

The etchants of the present invention can be used to contact the substrate where the polymer or via residue is to be removed by any known technique, such as dipping in a bath or preferably spraying the composition on the substrate or silicon wafer having the aluminum copper lines thereon. Typically, the composition is sprayed at a temperature of about 25 to about 95° C., and preferably at a temperature of about 30 to about 50° C., for about 1 to about 8 minutes, typical of which is about 2 minutes. Following this, the wafer can be subjected to a deionized water rinse followed by drying. For certain spin-spray processors, with HF content close to 100 ppm, process times less than 1 minute can be used.

The process of the present invention is also capable of removing chlorine embedded material along with the aluminum/copper sidewall polymer residue. The aluminum/copper profiles achieved by the present invention can be smoother than those in the prior art and are capable of being substantially free of electrochemical or accelerated etching of Al/Cu lines near tungsten studs.

The following Table I illustrates various etch rates of the Al/Cu with the etchant compositions of the present invention. The percentages in Table I are volume percents for 98 percent by weight H₂SO₄ and 30 percent by weight of H₂O₂ (remainder is H₂O).

TABLE 1
Etch rate of Al/Cu with sulfuric/peroxide
Etch rate of Al/Cu samples (Gravimetry) Sulfuric Peroxide

| Sulfuric | Peroxide | Etch Rate¹ | |
|---|---|---|---|
| (percent) | (percent) | (Angstroms/min) | Temperature ° C. |
| 2.5 | 2.5 | 51/116 | 35/45 |
| 2.5 | 5.0 | 57/109 | 35/45 |
| 5.0 | 2.5 | 68/148 | 35/45 |
| 5.0 | 5.0 | 59/136 | 35/45 |
| 7.5 | 5.0 | 78 | 35 |
| 7.5 | 7.5 | 77 | 35 |

¹Etch rate increases with temperature

Table 2 illustrates various etch rates of the aluminum with 0.5% copper alloy with the etchant compositions of the present invention. The percentages in Table II are volume percents for 98 percent by weight H₂SO₄ and 30 percent by weight of H₂O₂ (remainder is H₂O).

TABLE 2
Etch rate of Al/Cu with sulfuric/peroxide/hydrofluoric
(gravimetry)

| HF (ppm) | Etch Rate (Angstroms/min) |
|---|---|
| 0 | 18 |
| 10 | 69 |
| 20 | 107 |
| 30 | 173 |

Etch rates were evaluated by measuring the total Al/Cu etched (gravimetry) with 30 minute process time at about 35° C. The solution employed to develop Table II comprised about 9 percent by weight of sulfuric acid, 4 percent by weight of hydrogen peroxide with hydrofluoric acid, with the addition of the amounts of hydrofluoric acid shown in the first column and with the remainder of the solution comprising water.

The percentages shown above in Table I and Table II are exemplary only and others within the scope of the invention can likewise be employed. The measured etch rates were evaluated by averaging the total amount of Al—Cu etched over the process time.

In the context of the invention, it is also contemplated to provide process control for aqueous back-end-of-line (BEOL) clean for interconnects for the new aqueous clean. The aqueous chemistry is an aqueous mixture of sulfuric acid, hydrogen peroxide, and very small amounts of HF, and use of this chemistry in manufacturing introduces new challenges. Because of these new challenges, it is especially important to control and monitor the concentration of the active etching constituent, HF. This is so because, the concentration level of HF in the mixture is in the ppm range, thereby making it necessary to incorporate a feedback control mechanism to use this composition effectively for interconnect cleaning in the BEOL.

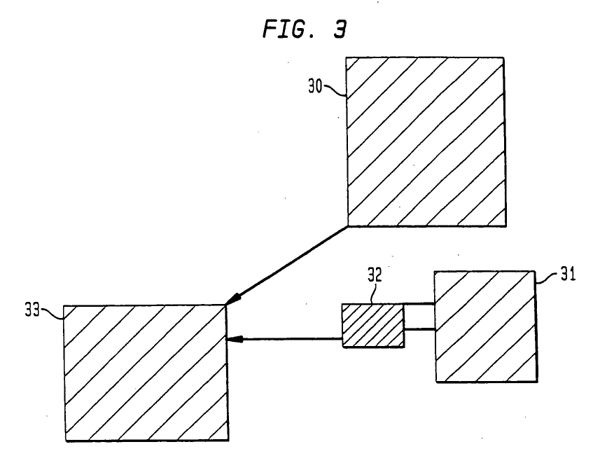

In the BEOL clean, the methodology used to deliver the chemistry to the open tank is first introduced, i.e., the tank is used to deliver the main chemicals for the process: water, sulfuric acid, and hydrogen peroxide, in the range already specified. The active component, HF, is mixed directly with the above mixture in the mixing tank or delivered directly to the bath separately. Reference is now made to FIG. 3, which shows the schematic of the methodology.

In FIG. 3, water, H₂SO₄ and H₂O₂ are placed in a mixing tank 30 in amounts previously specified. The active component HF, may be mixed directly into the mixing tank 30 delivered separately from tank 31 by use of spiking pump 32, into a tank for wafer processing 33 either before, during or after the mixture of water, H₂SO₄ and H₂O₂ is mixed in tank 30 and transported to the tank for wafer processing 33.

In order to use the chemistry of the aqueous composition effectively in production, it is necessary to monitor the active component, HF. Therefore, the control is set-up in an active mode where the concentration information is sent to the two controls for processing wafers in the chemistry tank 33 as follows:

a) a sample from the chemistry is taken for analysis;

b) the sample from the chemistry tank is sent to a HF monitor;

c) the value of the measured amount of HF is input to the tool recipe controls;

d) validation of the effective range within the process recipe is made to enable processing of the wafer lot;

e) the sample used for analysis is then sent to a process drain and is not used for processing wafers;

f) the foregoing steps a-e are repeated periodically, i.e., about 30 minutes.

This online HF monitoring set-up is verified periodically, and the value of the HF concentration is checked against the standard. The standard may be an ion selective electrode, which is well known in the art. Specifically, for the disclosure ranges, the range of HF is preferably set between 5 and 15 ppm, more preferably, between 7-12 ppm, and most preferably, in an operation range of between 8-10 ppm.

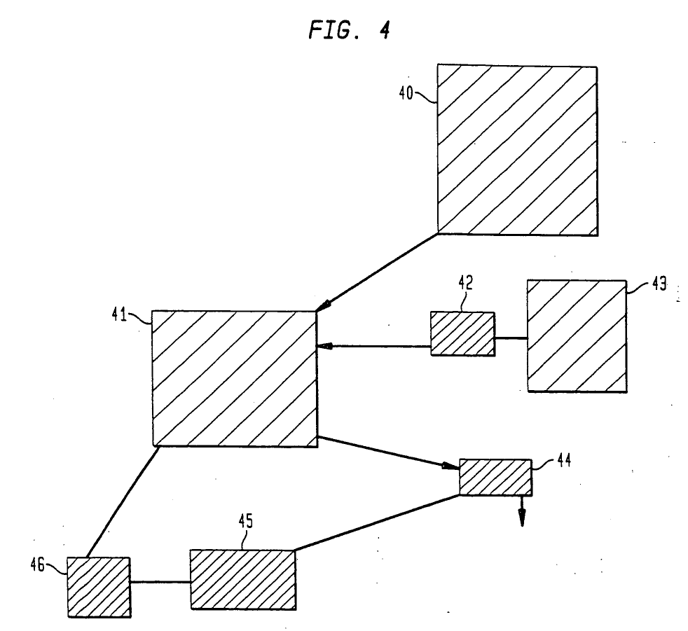

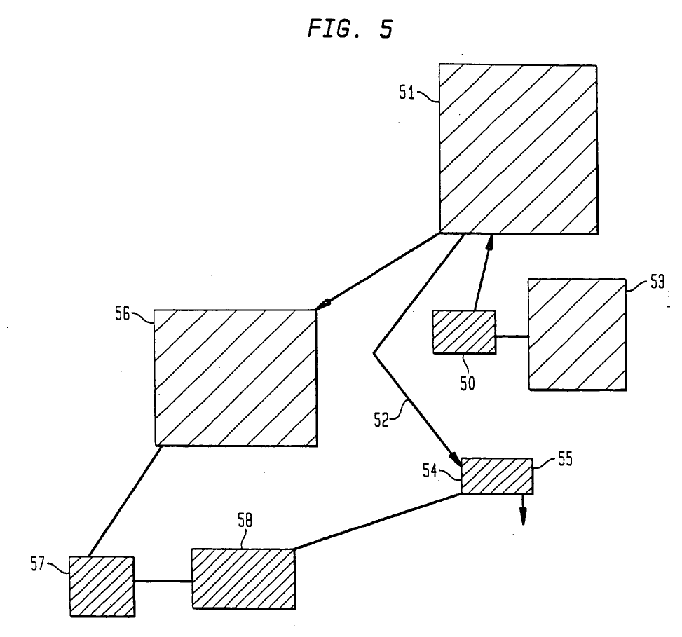

A schematic with the HF process control methodology is shown in FIG. 4, where a mixing tank 40 is employed to mix water, sulfuric acid and hydrogen peroxide. The mixture from tank 40 is then supplied to tank 41 for wafer processing, where a spiking pump 42 is used to supply a standard solution of dilute HF from tank 43. The mixture of water, H₂SO₄ and H₂O₂ and dilute solution of HF is sampled by a feedback loop for HF analysis to a chemical analyzer for HF 44. The value of the HF concentration is sent to a tank tool recipe control 45. If the HF concentration is too low, additional amounts of dilute HF is spiked from 43 into 41. If the concentration of HF is too high, additional amounts of a mixture of water, H₂SO₄ and H₂O₂ is supplied to tank 41 to enable the correct amount of mixture of water, H₂SO₄ and H₂O₂ to be mixed with the dilute standard solution of HF and added to the chamber for wafer processing 46. The sample taken from tank 41 is discarded or drained, as shown by the arrow leaving tank 44.

At the initial tank filling of tank 41, a sample is taken for analysis to determine the amount of the active component, HF. If the value is within the prescribed range as indicated by the tank toll recipe control, the wafers are processed in chamber 46. The control feedback schematic is as follows:

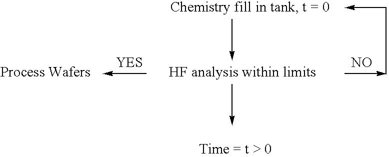

The process control feedback scheme shown above is for wafer processing in a tank; however, the process implementation may also be extended to wafer processing in a spray processor, where the chamber is either opened or closed.

Wafer processing in a spray processor utilizing the etchant composition of the invention is shown in FIG. 5. In FIG. 5, in which a spray processor is used, the HF spiking from spiking pump 50 is done directly in the mixing tank 51 for the initial mixing of water, sulfuric acid, and hydrogen peroxide after sample 52 taken from 51 subsequent to supplying a standard solution of dilute HF from tank 53, through a feedback loop 54 for chemical analysis of HF value by chemical analyzer 55. If the amounts of HF are too low, additional standard solution of dilute HF is spiked into tank 51. If the amount of HF is too high a lesser amount of HF is supplied from tank 53. When the correct ratio of the ingredients in the invention etching composition is obtained, the mixture is sent to a spray tool 56 and then sent to chamber 57, where the wafer is processed. As in the case of FIG. 4, the value of the sample taken for chemical analysis of HF at 55 is sent to a spray tool recipe control 58, and this measured value of input to the spray tool recipe control 58 affects validation of the effective range of HF to the chamber in which the wafer is processed. The actual sample taken for comparison in the chemical analyzer for HF is discarded or drained as shown by the arrow standing vertically downward from chemical analyzer 55.

In the context of the invention, a similar process control methodology is extendable to a single tank tool, where the processing chamber and the post water rinse would be done in the same tank.

In this disclosure there are shown and described only the preferred embodiments of the invention, but, as aforementioned, it is to be understood that the invention is capable of changes or modifications within the scope of the inventive concept as expressed.

What is claimed is:

1. A process for making a semiconductor device, the process comprising:
providing a semiconductor wafer;
preparing a first aqueous mixture;
combining a fluorine-containing compound with the first aqueous mixture to obtain an etchant composition;
taking a sample of the etchant composition;
comparing the sample to a standard dilute solution of the fluorine-containing compound to obtain a value of fluorine-containing compound concentration in said sample;
inputting the value to a tank tool recipe control to cause an adjustment in the concentration of the fluorine-containing compound in the etchant composition; and
subjecting a surface of the semiconductor wafer to etching by the etchant composition.

2. The process of claim 1, wherein the surface of the semiconductor wafer includes a metal.

3. The process of claim 2, further comprising:
depositing a layer of the metal over the semiconductor wafer; and
etching the layer of the metal using a reactive ion etch;
wherein the surface of the semiconductor wafer is subjected to etching by the etchant composition after etching the layer of the metal.

4. The process of claim 3, wherein using the reactive ion etch causes a sidewall polymer, polymer rails or via residue and wherein subjecting the surface of the semiconductor wafer to etching by the etchant composition removes the sidewall polymer, polymer rails or via residue.

5. The process of claim 2, wherein the metal comprises aluminum.

6. The process of claim 5, wherein the first aqueous mixture comprises water, sulfuric acid and hydrogen peroxide or ozone.

7. The process of claim 6, wherein the fluorine-containing compound comprises HF.

8. The process of claim 6, wherein the etchant solution comprises:
(i) about 0.01 to about 15 percent by weight of sulfuric acid;
(ii) about 0.1 to about 100 ppm of the fluorine containing compound; and
(iii) a component selected from the group consisting of about 0.01 to about 20 percent by weight of hydrogen peroxide and about 1 to about 30 ppm of ozone.

9. The process of claim 5, wherein the etchant solution comprises about 40 ppm to 100 ppm of HF.

10. The process of claim 1, wherein the fluorine-containing compound comprises HF.

11. The process of claim 10, wherein the etchant solution comprises about 40 ppm to 100 ppm of HF.

12. The process of claim 10, wherein said etchant composition comprises about 1 to about 10 percent by weight of sulfuric acid, about 1 to about 10 percent by weight of hydrogen peroxide, and about 1 to about 100 ppm of HF.

13. The process of claim 10, wherein said etchant composition comprises about 5 percent by weight of sulfuric acid, about 12 percent by weight of hydrogen peroxide, and about 10 ppm of hydrofluoric acid.

14. The process of claim 1, wherein the first aqueous mixture is mixed in a mixing tank and wherein combining a fluorine-containing compound comprises mixing the fluorine-containing compound directly into said mixing tank, wherein the concentration of the fluorine-containing compound is adjusted while the etchant composition is in the mixing tank.

15. The process of claim 1, wherein the first aqueous mixture is mixed in a mixing tank and wherein combining a fluorine-containing compound comprises adding the fluorine-containing compound into a separate vessel and transporting the first aqueous mixture to said separate vessel, wherein the concentration of the fluorine-containing compound is adjusted while the etchant composition is in the separate vessel.

16. The process of claim 15, wherein the separate vessel comprises a tank for wafer processing.

17. The process of claim 16, wherein said tank for wafer processing comprises a spray processor.

18. A process for subjecting a reactive ion etched semiconductor device to a post metal RIE clean using an etchant composition, the process comprising:
mixing water, sulfuric acid and hydrogen peroxide or ozone;
combining a fluorine-containing compound with the mixture of water, sulfuric acid and hydrogen peroxide or ozone to obtain an etchant composition;
taking a sample comprising the fluorine-containing compound and sending said sample through a feedback loop;
comparing said sample to a standard dilute solution of the fluorine-containing compound to obtain a value of fluorine-containing compound concentration in said sample;
inputting said value to a tank tool recipe control to cause an adjustment in the concentration of the fluorine-containing compound; and
subjecting a wiring/interconnect of a semiconductor device to etching by said etchant composition.

19. The process of claim 18, wherein said fluorine-containing compound comprises hydrofluoric acid.

20. The process of claim 19, wherein said etchant composition comprises about 1 to about 10 percent by weight of sulfuric acid, about 1 to about 10 percent by weight of hydrogen peroxide, and about 1 to about 100 ppm of hydrofluoric acid.

21. The process of claim 18, wherein said etchant composition comprises about 0.01 to about 2.0 percent by weight of hydrogen peroxide.

22. The process of claim 18, wherein said etchant composition comprises about 1 to about 30 ppm of ozone.

23. The process of claim 18, wherein said etchant composition includes deionized water.

24. The process of claim 18, wherein the etchant composition comprises:
(i) about 0.01 to about 15 percent by weight of sulfuric acid;
(ii) about 0.1 to about 100 ppm of the fluorine-containing compound; and
(iii) a component selected from the group consisting of about 0.01 to about 20 percent by weight of hydrogen peroxide and about 1 to about 30 ppm of ozone.

25. The process of claim 18, wherein the water, sulfuric acid and hydrogen peroxide or ozone are mixed in a mixing tank and wherein combining a fluorine-containing compound comprises mixing the fluorine-containing compound directly into said mixing tank, wherein the concentration of the fluorine-containing compound is adjusted while the etchant composition is in the mixing tank.

26. The process of claim 18, wherein the water, sulfuric acid and hydrogen peroxide or ozone are mixed in a mixing tank and wherein combining a fluorine-containing compound comprises adding the fluorine-containing compound into a separate vessel and transporting the mixture of water, sulfuric acid and hydrogen peroxide or ozone to said separate vessel, wherein the concentration of the fluorine-containing compound is adjusted while the etchant composition is in the separate vessel.

27. The process of claim 26, wherein the separate vessel comprises a tank for wafer processing.

28. The process of claim 18, wherein said tank for wafer processing comprises a spray processor.

29. The process of claim 18, wherein subjecting the wiring/interconnect of the semiconductor device to etching by said etchant composition comprises removing sidewall polymer, polymer rails and via residue without etching conductive materials during the removal of the sidewall polymer, polymer rails, and via residue.

30. A method for cleaning semiconductor devices using an etchant composition, the method comprising:
a) mixing water, sulfuric acid and one of hydrogen peroxide or ozone in a mixing tank;
b) mixing HF directly into said mixing tank or adding HF into a separate tank for wafer processing, either before, during or after said mixture of said water, sulfuric acid and hydrogen peroxide or ozone is transported to a tank for wafer processing; and
c) subjecting a semiconductor device to etching by said etchant composition to remove sidewall polymer, polymer rails and via residue without etching conductive materials during removal of sidewall polymer, polymer rails, and via residue;
wherein said etchant composition comprises:
(i) about 0.01 to about 15 percent by weight of sulfuric acid;
(ii) about 0.1 to about 100 ppm of HF; and
(iii) either about 0.1 to about 20 percent by weight of hydrogen peroxide or about 1 to about 30 ppm of ozone.
